(19) United States
(12) Patent Application Publication
(10) Pub. No.: US 2006/0149862 A1
(43) Pub. Date: Jul. 6, 2006

(54) DMA in processor pipeline

(75) Inventors: Abdelhafid Zaabab, Duluth, GA (US); Aashutosh Joshi, Lilburn, GA (US); Rajneesh Kumar Salnl, Sunnyvale, CA (US)

Correspondence Address: IVIVITY, INC., 5555 OAKBROOK PKWY, SUITE 280, NORCROSS, GA, 30093-2286, US

(73) Assignee: iVivity, Inc.

(21) Appl. No.: 11/327,609

(22) Filed: Jan. 6, 2006

Related U.S. Application Data
(60) Provisional application No. 60/641,795, filed on Jan. 6, 2005.

(51) Int. Cl. G06F 13/28

(52) U.S. Cl. 710/22

(57) ABSTRACT

The present technique is an atomic technique that places a triggered operation within a processor pipeline, whereby the processor is stalled until the triggered operation is completed. A processor issues an access operation that will trigger an external block operation. The external operation does not return an access valid until the operation is complete.

### CROSS REFERENCE TO RELATED APPLICATIONS

This application claims priority to the U.S. provisional application No. 60/641,795 titled “DMA In Processor Pipeline” filed on Jan. 6, 2005, which is incorporated in its entirety by reference.

### FIELD OF THE INVENTION

The present invention generally relates to data processing. More specifically, the present invention relates to an atomic technique that places a triggered operation within a processor pipeline, whereby the processor is stalled until the triggered operation is completed.

### BACKGROUND

For most applications a DMA operation is often required to move data from one memory location to another or from external memory to processor internal memory and vice versa. In prior art, when the processor issues a DMA operation, it either polls the DMA status register periodically until the DMA complete flag is set, or switches contexts by putting the DMA thread to sleep until a DMA complete interrupt is received, at which time the processor will switch back to the DMA thread. Both scenarios require the processor to keep performing non-useful processing by continuously polling a status register or executing a costly operation of context switching before and after the DMA interrupt is generated. These scenarios also will increase the processor power consumption as well. For shorter DMA count operations, it is often the case that the context switching consumes more cycles than it is required to DMA the data.

In a typical prior art DMA execution flow, after writing the source address, the destination address, the count, and the DMA read or write direction, the DMA is started by writing a start bit or as a direct result of the direction read/write register. After starting the DMA operation, the processor enters a polling loop depicted to check the DMA completion bit by continuously reading the DMA status register. The processor exits the polling loop when the DMA is done and the completion bit is set. The continuous polling of the DMA status register is considered non-constructive processing and adds to the power consumption.

In DMA interrupt mode, however, after the DMA is started the processor continues performing other work. In this case, when the DMA in done, an interrupt is generated and this forces the processor to enter an interrupt mode where it will stop its current execution flow, saves the current state parameters to the stack and executes a DMA interrupt routine where it will check the dam status completion, clears the interrupt and then exits the interrupt by reading back the last saves state from the stack and continue the normal execution flow. This context swapping to and from the stack is a costly operation that required many writes and reads from the stack memory. For shorter DMA count operations, it is often the case that this context switching consumes more cycles than it is required to DMA the data.

For today's high data rates and higher bandwidth requirements from ASICs and SOCs, the prior art implementations are not adequate. Hence, there is a need for a DMA operation that overcomes the shortcomings of both prior art polling and interrupt modes suitable for an SOC ASIC implementation.

A firmware-hardware atomic DMA technique that avoids system bottlenecks is needed. Such a system allows for an efficient power consumption usage. In order to address the above-mentioned needs, a new DMA technique places the DMA operation within the processor pipeline, whereby the DMA start operation becomes an integral instruction of the processor instruction set.

### SUMMARY OF INVENTION

The present technique is an atomic technique that places a triggered operation within a processor pipeline, whereby the processor is stalled until the triggered operation is completed. A processor issues an access operation that will trigger an external block operation. The external operation does not return an access valid until the operation is complete.

Specifically, for DMA access, a processor issues a DMA instruction that triggers a DMA transfer. The DMA transfer is triggered by a register access operation of a DMA register. The register access operation does not return an access valid until the DMA transfer is complete.

### BRIEF DESCRIPTION OF THE DRAWINGS

Benefits and further features of the present invention will be apparent from a detailed description of preferred embodiments thereof taken in conjunction with the following drawings, wherein like reference numbers refer to like elements, and wherein:

FIG. 1 illustrates a prior art DMA execution flowchart.

FIG. 2 shows an improved DMA execution flowchart.

FIG. 3 depicts a block diagram with a processor and a hardware DMA bus connections.

### DETAILED DECRIPTION OF THE DRAWINGS

The present invention is a firmware-hardware atomic DMA technique that minimizes system bottlenecks. The new DMA technique places the DMA operation within the processor pipeline, whereby the DMA start operation becomes an integral instruction of the processor instruction set. A significant advantage of this scheme is that at DMA operation completion, the processor has available the status register data without the need to issue another load of that register to determine the status of the DMA operation.

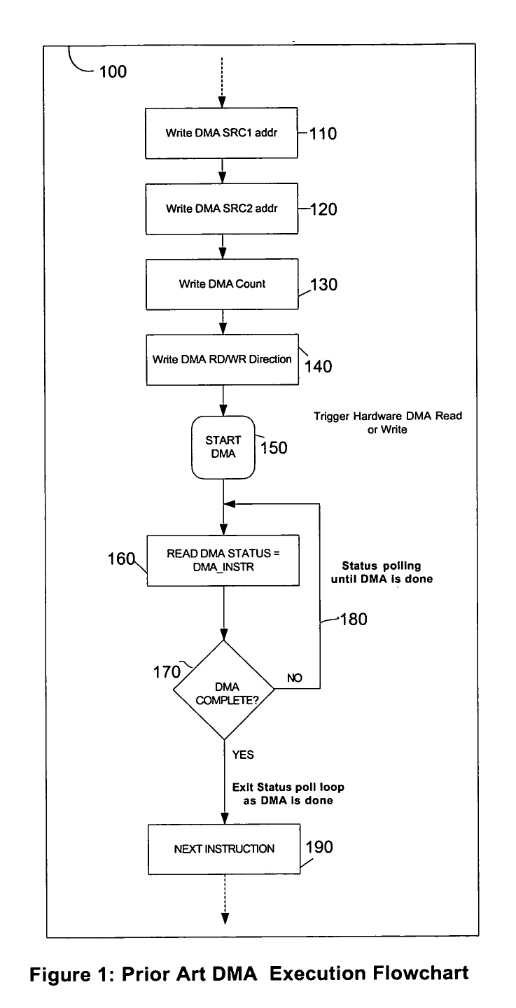

Turning now to the figures, FIG. 1 illustrates a typical prior art DMA execution flow 100 where after writing the source address 110, the destination address 120, the count 130 and the DMA read or write direction 140, the DMA is started 150 by writing a start bit or as a direct result of the direction read/write register 140. After starting the DMA operation 150, the processor enters a polling loop depicted by 160, 170, and 180, to check the DMA completion bit by continuously reading the DMA status register. The processor exits the polling loop when the DMA is done and the completion bit is set. The continuous polling of the DMA status register is considered non constructive processing and adds to the power consumption.

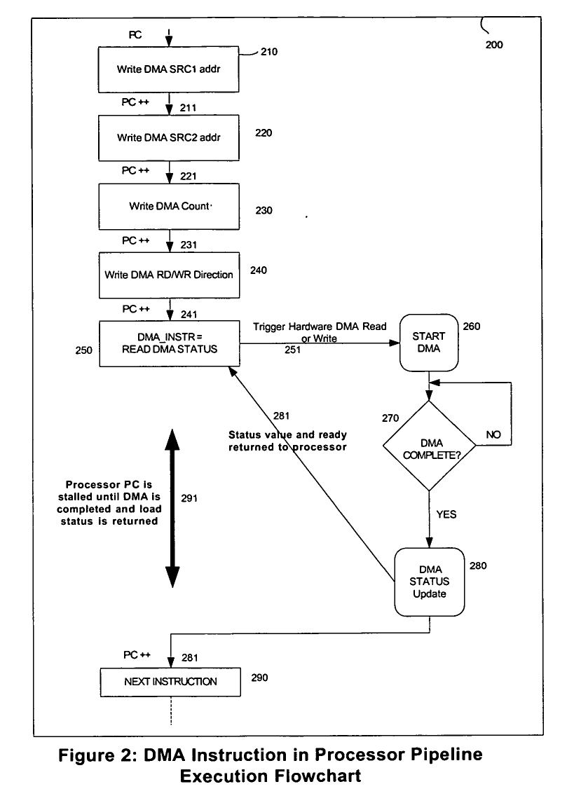

In accordance with the present invention, FIG. 2 shows an embodiment of a DMA execution flow incorporating the proposed DMA instruction. After the DMA initialization performed in 210 to 240 in flowchart 200, the DMA operation is launched by issuing the new DMA instruction, which we will refer to hereafter by “dma_inst”. This dma_inst is a load operation of the DMA status register which will not complete until the DMA complete bit in the status register is set indicating the DMA is done. After issuing the dma_inst, the processor is stalled until the DMA in done. This stalling of the processor pipeline is depicted in FIG. 2, by the processor program counter not being updated after 241 until 281 when the DMA is done. With this scheme, when the DMA operation is launched by issuing the dma_inst, the processor does not have to perform or execute until the DMA load command register operation is finished. Optionally, the processor can transition to a low power mode during this operation. The DMA operation becomes similar to the processor performing a normal load operation.

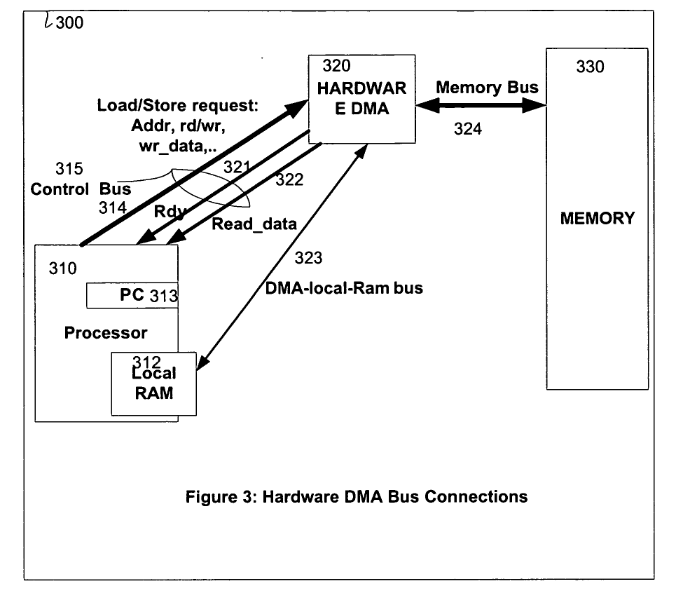

FIG. 3 illustrates a block diagram 300 showing hardware DMA connections to the processor and memories. It is to be noted that the DMA block 320 can either be outside the processor 310 boundary and connected through a system bus 315 or provided as part of the processor block 310 and connected through an internal processor bus. In 300, when the processor 310 issues the dma_inst load operation through the control bus 315, the ready signal rdy 321 and read_data 322 are not returned (set valid) until the DMA 320 is done and the complete bit is set.

Those skilled in the art will recognize that there are many ways to generate the DMA instruction and in the preferred embodiment, the dma_inst instruction is a load operation 250 of the DMA status register, but which will not complete until the DMA complete bit is set. An alternative method is to make the dma_inst a write command operation that writes either the read/write dma direction register or start DMA register if separate. In the later case, however, the write instruction calls for a ready signal returned to be able to stall it until the DMA in done.

In the proposed scheme the DMA instruction, dma_inst, is provided as part of the processor instruction set of the re-configurable processor where the processor and its compiler allows adding user instructions. For non-re-configurable processors, however, the same result is realized by holding the completion of the normal last load or store operation that fires the DMA until the DMA is completed.

With the present invention, there is no need for continuously polling or context switching on DMA interrupt. This technique greatly simplifies code development and removes the complexity of multi-context coding. With the usage of the dma_inst, the whole DMA routine is simplified and reduced in size which reduces the obstacles to put the whole DMA code as inline code whenever needed. This greatly simplifies code development and debugging.

A further advantage of this scheme is that at DMA completion, the processor has available the status register data without the need to issue another load of that register to determine the status of the DMA operation as would be required in the case of interrupt mode. This benefit adds to the code size savings and processor speed up.

It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustrations, which are intended to define the exclusive rights of the invention.

The invention claimed:

1. A method for direct memory access, comprising:
issuing a DMA instruction that triggers a DMA transfer, wherein the DMA transfer is triggered by a register access operation of a DMA register; and
said register access operation does not return an access valid until the DMA transfer is complete.

2. The method of claim 1 wherein the DMA register is a DMA status register.

3. The method of claim 1 wherein the register access operation is a read operation.

4. The method of claim 1 wherein the register access operation is a write operation.

5. A system for data processing, comprising:
a processor, wherein the processor issues an instruction that triggers an operation transfer;
a hardware block, wherein the hardware block returns an access valid after the operation transfer is complete; and
a bus coupling the processor and the hardware block.

6. The system of claim 8 wherein the hardware block is a DMA block.

7. The system of claim 8 wherein the instruction is a DMA instruction.

8. The system of claim 8 wherein the operation transfer is a DMA transfer.

9. A method for data processing, comprising:
issuing an access operation that triggers a hardware operation,
wherein the hardware operation does not return an access valid until the operation is complete.

10. A method for data processing, comprising:
issuing an access operation that triggers a second operation stalls a process until an access valid is returned,
wherein the access valid is generated after the second operation is complete.

11. The method of claim 13 wherein the second operation is a DMA transfer operation.

12. The method of claim 13 wherein the access operation is a DMA instruction.
